(19) United States
(12) Patent Application Publication
(10) Pub. No.: US 2011/0057627 A1
(43) Pub. Date: Mar. 10, 2011

(54) Discharge circuit for high-voltage networks

(76) Inventor: Jochen Kuehner, Backnang (DE)

(21) Appl. No.: 12/919,403

(22) PCT Filed: Dec. 30, 2008
(86) PCT No.: PCT/EP08/68340

§ 371 Date: Nov. 17, 2010

(30) Foreign Application Priority Data
Feb. 25, 2008 (DE) 102008010978.9

(51) Int. Cl. H02J 7/00

(52) U.S. Cl. 320/166

(57) ABSTRACT

A device for discharging an electric network or a capacitive component includes a switchable resistor. The discharge circuit has a particularly low power loss and operates reliably when the switchable resistor includes a PTC resistor and a switch whose control terminal is powered by the network voltage.

### FIELD OF THE INVENTION

The present invention relates to a device for discharging an electric network or an electric component.

### BACKGROUND INFORMATION

Voltages that may rise to several hundred volts are used in hybrid vehicles or vehicles having an electric drive. Voltages higher than 60 volts are referred to as “high voltages.” For reasons of personal safety, it must be possible to switch off and discharge high-voltage vehicle electrical systems. For this purpose, known high-voltage vehicle electrical systems include an active or passive discharge device. One known passive discharge device is made up of a resistor that is connected in parallel to an energy store, such as a capacitor, for example. During operation, the capacitor is constantly discharged through the resistor. The resistor causes a permanent power dissipation, which may amount to 10 W or more. Furthermore, the discharge resistor must normally be installed on a heat sink due to the high permanent power dissipation.

One active discharge device may include a switchable resistor that is able to be switched on and off via a switch. The resistor is switched off during normal operation and is automatically switched on by a control device upon request. Thus, the resistor only has to be designed for the energy to be discharged, and not for permanent power dissipation. If the control device malfunctions, there is the possibility that the switch is not activated on time or is not activated at all. When this happens, the vehicle electrical system is not discharged such that there exists the risk of an electric shock. An additional risk is that the main switch to the supply network or to the battery mistakenly may not open and the discharge resistor may thus be destroyed.

### SUMMARY OF THE INVENTION

It is therefore an objective of the exemplary embodiments and/or exemplary methods of the present invention to create a discharge circuit for an electric high-voltage network, which operates with greater reliability, produces less waste heat, and furthermore is intrinsically safe.

This objective is attained according to the exemplary embodiments and/or exemplary methods of the present invention by the features described herein. Additional refinements of the exemplary embodiments and/or exemplary methods of the present invention result from the further descriptions herein.

An important aspect of the exemplary embodiments and/or exemplary methods of the present invention is to implement a discharge circuit having a PTC resistor, and to activate and deactivate the PTC resistor via a switch whose control terminal is supplied with current (directly or indirectly) by the network voltage. The switch and the PTC resistor are thermally coupled and act as a regulated current sink. As soon as the switch is closed, the PTC resistor is heated by the transistor and it increases its resistance. Thus, the control voltage of the transistor changes, so that the discharge current through the transistor and the PTC resistor is decreased. Since the switch is powered by the network to be discharged, the function of the discharge circuit is guaranteed in every instance, independently of a control device.

The switchable resistor may be connected in parallel to a component to be discharged, such as a capacitor, for example. In accordance with one specific embodiment of the present invention, a separate discharge circuit, that is, an independent PTC resistor, is provided for each capacitive component. In this instance, the PTC resistor only has to convert the energy stored in the capacitive element into heat. Alternatively, it is possible to discharge a plurality of capacitors and capacitive components via one discharge circuit. The circuit is at the same time intrinsically safe if, for example, the main switch to the supply network/battery was not opened.

The switch may include a transistor, such as a MOS transistor, for example.

A second switch, via which the first switch may be activated and deactivated, may be connected to the control terminal (e.g., gate) of the switch. The second switch may be connected between the control terminal of the first switch and a reference potential (e.g., ground). The control terminal of the first switch thus may be optionally connected to the reference potential or the network voltage or a voltage derived therefrom.

The control terminal of the first switch may be connected to the network potential via a resistor. This resistor may have an ohmic resistance of several 100 kOhm.

In accordance with a special specific embodiment of the present invention, a Zener diode is connected to the control terminal of the first switch. The Zener diode may be disposed in parallel to the second switch and is used to provide a constant voltage for the current regulation.

The discharge circuit according to the present invention may also include a control unit, such as a control device, for example, that is connected to a control terminal of the second switch and that controls the latter. During normal operation, the second switch may be switched through (conductive). The first switch is thus highly resistant and no current flows through the PTC resistor. In the event of a discharge request, the second switch is opened and the first switch is thus closed. The network or the component are thus discharged via the PTC resistor.

The discharge process may be implemented after a “vehicle ignition OFF” action, after a collision of the vehicle, or before performing maintenance work.

The above-described discharge circuit is used for hybrid vehicles, in particular, but may also be used for electric vehicles or fuel cell vehicles.

In the following, the exemplary embodiments and/or exemplary methods of the present invention is explained in greater detail by way of example with reference to the attached drawings.

### BRIEF DESCRIPTION OF THE DRAWING

FIG. 1 shows a schematic representation of a discharge circuit for a high-voltage network.

### DETAILED DESCRIPTION

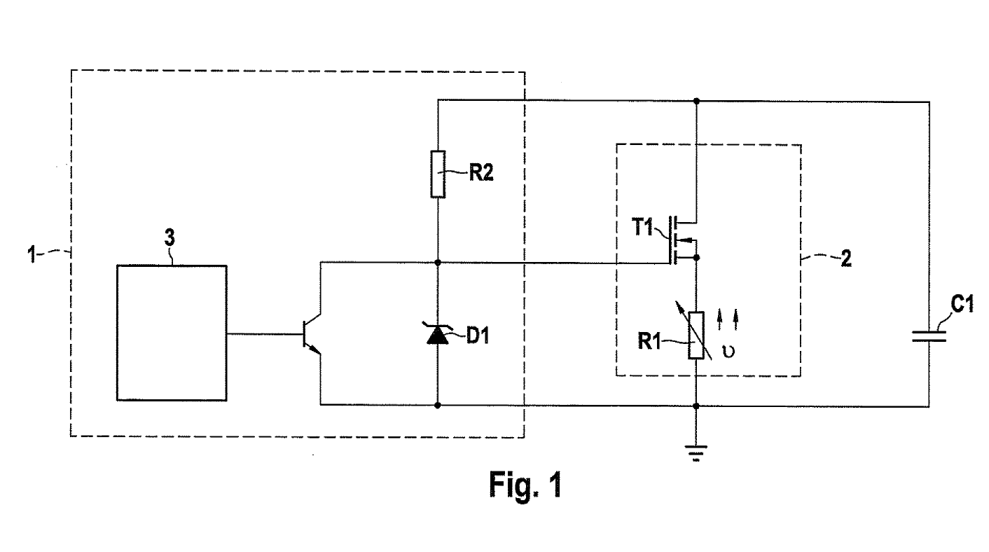

FIG. 1 shows a simplified illustration of a discharge circuit for a high-voltage vehicle electrical system of a hybrid vehicle. The voltage of the high-voltage network may be 400 volts, for example. In this instance, the discharge circuit is used to discharge a capacitor C1, but may also be used for other capacitive components. Such capacitors C1 are normally used as buffer capacitors, in order to stabilize the operating voltage of the electric consumers.

In specific situations, such as after an accident or before vehicle maintenance, for example, the charge stored in buffer capacitor C1 must be quickly reduced. For this purpose, a switchable resistor 2 is provided, which is connected in parallel to capacitor C1. In this context, the supply connection is connected to network voltage V and the second connection is connected to ground.

Switchable resistor 2 includes a MOS transistor T1 and a PTC resistor R1 (PTC: positive temperature coefficient). The two components are connected in series, PTC resistor R1 being disposed on the ground side. Transistor T1 and PTC resistor R1 are thermally coupled and may be disposed on a circuit board. Control terminal G is connected to supply voltage V via a resistor R2.

During normal operation, transistor T1 is open and is closed upon request. Capacitor C1 then discharges via transistor T1 and PTC resistor R1. In this context, the current flow is limited to a maximum value by PTC resistor R1. During this process, the switch and the PTC resistor act as a regulated current sink. As soon as transistor T1 is closed, PTC resistor R1 is heated by transistor T1 and it increases its resistance.

Thus, the control voltage of the transistor changes so that the discharge current through the transistor and the PTC resistor is reduced.

A control circuit 1 is provided to trigger transistor T1, and is connected to control terminal G of transistor T1. Control circuit 1 includes a second switch T2, which is implemented as a bipolar transistor in this instance. Bipolar transistor T2 is connected between control terminal G and ground and is triggered by a control unit 3.

Transistor T2 is conductive during normal operation and thus draws control terminal G to ground. Second transistor T2 becomes highly resistive upon request or in the event of a voltage drop. First transistor T1 is thus closed. First transistor T1 then powers itself from the electric network. Capacitor C1 is thus discharged via transistor T1 and PTC resistor R1.

Furthermore, a Zener diode D1, which protects transistor T1 from excessive voltages and provides a constant voltage, is connected to control terminal G of transistor T1.

In the case of a plurality of capacitive components (C1) a separate discharge circuit may be assigned to each component.

1-6. (canceled)

7. A device for discharging one of an electric network and an electric component, comprising:
a switchable resistor, including:
a PTC resistor, and
a switch, wherein the PTC resistor and the switch are thermally coupled;
wherein a control terminal of the switch is connected to a network voltage.

8. The device of claim 7, wherein the switchable resistor is connected in parallel to the electric component to be discharged.

9. The device of claim 7, wherein a second switch is connected to the control terminal of the switch, by which the second switch via the control terminal may be connected optionally to one of a network voltage and a reference voltage.

10. The device of claim 7, wherein the control terminal of the switch is connected to the network voltage via a resistor.

11. The device of claim 7, wherein a Zener diode is connected to the control terminal of the switch.

12. The device of claim 9, further comprising:
a control unit to trigger the second switch.
